(19) United States
(12) Patent Application Publication
(10) Pub. No.: US 2013/0297299 A1
(43) Pub. Date: Nov. 7, 2013

(54) Sparse Auditory Reproducing Kernel (SPARK) Features for Noise-Robust Speech and Speaker Recognition

(71) Applicant: BOARD OF TRUSTEES OF MICHIGAN STATE UNIVERSITY, East Lansing, MI (US)

(72) Inventors: Shantanu Chakrabartty, Williamston, MI (US); Amin Fazeldehkordi, Rochester Hills, MI (US)

(73) Assignee: Board of Trustees of Michigan State University, East Lansing, MI (US)

(21) Appl. No.: 13/788,385

(22) Filed: Mar. 7, 2013

Related U.S. Application Data
(60) Provisional application No. 61/643,550, filed on May 7, 2012.

(51) Int. Cl. G10L 15/02

(52) U.S. Cl. CPC G10L 15/02
USPC 704/211

(57) ABSTRACT

The speech feature extraction algorithm is based on a hierarchical combination of auditory similarity and pooling functions. Computationally efficient features referred to as “Sparse Auditory Reproducing Kernel” (SPARK) coefficients are extracted under the hypothesis that the noise-robust information in speech signal is embedded in a reproducing kernel Hilbert space (RKHS) spanned by overcomplete, nonlinear, and time-shifted gammatone basis functions. The feature extraction algorithm first involves computing kernel based similarity between the speech signal and the time-shifted gammatone functions, followed by feature pruning using a simple pooling technique (“MAX” operation). Different hyper-parameters and kernel functions may be used to enhance the performance of a SPARK based speech recognizer.

### FIELD

The present disclosure relates to computer-implemented speech processing and more particularly to a speech feature extraction technique that improves performance of automatic speech recognizers in the presence of noise.

### BACKGROUND

This section provides background information related to the present disclosure which is not necessarily prior art.

Computer-implemented, automatic speech recognizers today are essentially complex pattern recognition systems that compare the incoming speech utterance to a set of trained speech models stored within the memory of the recognizer or accessible to the recognizer via a communications link. The speech models are typically trained under controlled conditions by supplying a corpus of speech data (e.g., utterances from human subjects reading assigned text passages).

Once trained, the models are made available to the recognizer which processes input speech by testing how well the incoming speech matches each of the trained models. Typically recognition probability scores are generated for each model. Thus for a recognizer supplied with in incoming utterance, “cat,” the trained “cat” model might return a probability score of 98%; the trained “bat” model might return a probability score of 70%; and the “aardvark” model would likely return a recognition probability score of 0%. The foregoing is merely a simplified example to demonstrate the basic recognition concept. While recognizers can work with speech models trained to recognize specific words (as in this example), they can also be trained to recognize continuous speech, where the trained models are based on more fundamental sounds such as phonemes rather than words; they can also be trained to recognize different speakers' voices, where each speaker to be recognized provides training data that are used to train models for that speaker.

Some recognizers are also capable of adapting or improving the speech models while the system is being used. In such systems, the initially provided speech models are adapted to improve recognition probability scores, based on utterances received from users as the system is being used. Anyone who has used a speech recognizer for dictation will understand that these systems learn the user's unique speech patterns over time. What is actually happening behind the scenes is that the speech models are being adapted to that user's voice.

Speech recognizers work fairly well under optimal conditions, where the incoming speech is obtained under conditions similar to those used when the training data was collected. Variation from these optimal conditions can rapidly degrade recognition performance. Microphone placement (proximity to user's mouth) and background noise are two factors that significantly affect the recognizer's performance. If a user utters words in a noisy environment, perhaps with less than optimal microphone placement (such as in a moving vehicle, or via a mobile phone in a noisy place, the recognition probability scores drop precipitously. Recognition results suffer. Some systems attempt to compensate for poor recognition by resorting to additional or more computationally intensive recognition algorithms. Recognition performance may improve, but the time required to perform the recognition will likely increase. This is one reason why mobile phone-based recognition systems will sometimes take a long time to recognize a phrase which on other occasions it was able to quickly recognize.

As discussed more fully in this disclosure, there are several techniques that can be used to improve recognizer performance under difficult conditions such as in the presence of noise or when the communication channel is degraded (through poor microphone placement or other transmission loss). The present disclosure attacks the problem by improving the way the speech signals are processed to extract features that are used to train the speech models and then used to process the incoming speech.

Discussion of Feature Extraction

When human speech is processed so that an automatic speech recognizer can analyze it, the speech is captured in analog form by a microphone and then digitized by analog to digital convertor. This converts the human speech into a time-domain sequence of digital values representing the instantaneous waveform amplitude at sample of the waveform extracted by the analog to digital convertor. In its native digitized form, the speech signal can be of any length, dictated by how long was the utterance. Pattern recognition of a time-domain sequence of digital values of indeterminate length is an intractable problem. Therefore, to make pattern recognition possible, the digitized speech signal is first broken into units of predefined length. This process is known as “windowing.” Windowing breaks the digital data stream into smaller, fixed length chunks that can be fed to the recognizer, one chunk at a time.

However, it turns out that processing chunks of raw digital speech data in the time domain remains largely unsuccessful because even for the same word uttered several times, the raw digital speech data will vary significantly from utterance to utterance. Thus comparing utterance A with utterance B on the basis of individual raw digital speech data points is not effective. Speech recognizer systems deal with this by extracting “features” from the raw digital speech data. The goal is to identify features that are effective in discriminating utterance A from utterance B, while reducing the number of comparisons that need to be performed. Many speech recognizers today are based on extracted features known as “cepstral coefficients.”

As will be more fully described below, the present disclosure seeks to improve automatic speech recognition and automatic speech recognizers by utilizing a new way of extracting features from the speech signal.

Therefore, to reiterate, unlike human audition, the performance of speech-based recognition systems degrades significantly in the presence of noise and background interference. This can be attributed to inherent mismatch between the training and deployment conditions, especially when the characteristics of all possible noise sources are not known in advance. Therefore, in literature several strategies have been proposed that can reduce the effect of this mismatch. They can be broadly categorized into three main groups: 1) speech enhancement techniques that can filter out the noise in the spectral or temporal domain; 2) robust feature extraction techniques that can generate speech features that are invariant to channel conditions; and 3) back-end adaptation techniques that can reduce the effect of training-deployment mismatch by adjusting the parameters of a statistical recognition model. Even though significant improvements in recognition performance can be expected by the application of the third approach, the overall system performance is still limited by the quality of the speech features. Therefore, this disclosure focuses on extraction of speech features that are robust to mismatch between training and testing conditions.

Traditionally, speech features used in most of the state-of-the-art speech recognition systems have relied on spectral-based techniques which include Mel-frequency cepstral coefficients (MFCCs), linear predictive coefficients (LPCs), and perceptual linear prediction (PLP). Noise-robustness is achieved by modifying these well-established techniques to compensate for channel variability. For example, cepstral mean normalization (CMN) and cepstral variance normalization adjust the mean and variance of the speech features in the cepstral domain to reduce the effect of convolutive channel distortion. Another example is the Relative spectra (RASTA) technique which suppresses the acoustic noise by high-pass (or band-pass) filtering of the log-spectral representation of speech. More recently, advanced signal processing techniques like the feature-space non-linear transformation techniques, the ETSI advanced front end (AFE), stereo-based piecewise linear compensation (SPLICE) and power-normalized cepstral coefficients (PNCC), have been used to improve the noise-robustness. The AFE approach, for example, integrates several methods to remove the effects of both additive and convolutive noises. A two-stage Mel-warped Wiener filtering, combined with an SNR-dependent waveform processing is used to reduce the effect of additive noise and a blind equalization technique is used to mitigate the channel effects.

An alternate and a promising approach towards extracting noise-robust speech features is to use data-driven statistical learning techniques that do not make strict assumptions on the spectral properties of the speech signal. Examples include kernel based techniques which operate under the premise that robustness in speech signal is encoded in high-dimensional temporal and spectral manifolds which remain intact even in the presence of ambient noise and the objective of the feature extraction procedure is to identify the parameters of the noise-invariant manifold. The procedure used in a standard kernel based technique required solving a quadratic optimization problem for each frame of speech which made the data-driven approach highly computationally intensive. Also, due to its semi-parametric nature, the methods proposed in prior systems did not incorporate any a priori information available from neurobiological and psycho-acoustical studies, which have been shown to be important for speech recognition. More recently, it has been demonstrated that cortical neurons use highly efficient and sparse encoding of visual and auditory signals. It has been shown that auditory signals can be sparsely represented by a group of basis functions which are functionally similar to gammatone functions which are equivalent to time-domain representations of human cochlea filters, also used in psycho-acoustical studies. Other neurobiological studies have proposed a hierarchical auditory processing model consisting of spectro-temporal receptive fields (STRFs) that capture information embedded in different frequency, spectral and temporal scales. The results from many of these recent neurobiological and psycho-acoustical studies are being incorporated in small-scale speech recognition systems.

### SUMMARY

This section provides a general summary of the disclosure, and is not a comprehensive disclosure of its full scope or all of its features.

Departing from the convention cepstral coefficient techniques, the disclosed method and apparatus provides a computationally efficient, hierarchical auditory feature extraction method and apparatus that uses a transformation technique, such as a non-linear reproducing kernel Hilbert space (RKHS) transformation of gammatone basis functions.

More specifically, the method and apparatus processes the time domain speech signal, digitally represented as a vector of a first dimension, and converts that vector into a speech feature vector that has advantageous properties when compared with conventional cepstral coefficient-based feature vectors.

The method operates on the time domain speech signal, stored in memory of a processor. A set of gammatone basis functions, represented as a set of gammatone basis vectors of the first dimension are also stored in the memory of the processor. The processor applies a reproducing kernel function to transform the stored gammatone basis vectors and the stored speech signal to a higher dimensional space. Then, using the processor, a set of similarity vectors is computed in said higher dimensional space based on the stored gammatone basis vectors and the stored speech signal. The processor then applies an inverse function to transform the set of similarity vectors in said higher dimensional space to a set of similarity vectors of the first dimension, and then selects one of the set of similarity vectors of the first dimension as a processed representation of said speech signal.

The transformation from higher dimensional space to the first dimension effects a nonlinear transformation. The nonlinear transformation and use of gammatone basis functions thus generates an extracted speech feature vector that represents many of the nuances of human speech better than conventional cepstral coefficients. The higher dimensional space may be described as a Hilbert space and where the transformation is a reproducing kernel Hilbert space RKHS transformation. To reduce the computational burden on the processor, the transformation may be performed by precomputing and storing in memory a transformation matrix and using the transformation matrix to perform the step of applying an inverse function.

In addition to the foregoing steps and operations, the method and apparatus may additionally apply a regularization parameter that penalizes large similarity values to enhance robustness of the processed representation of said speech signal in the presence of noise. The method and apparatus may also perform the step of selecting one of said set of similarity vectors by applying a winner-take-all function. In addition, the method and apparatus may further use the processor to apply a compressive weighting function to the selected one of said set of similarity vectors. The compressive weighting function may be configured to enhance the resolution at low similarity scores and reduce the resolution at high similarity scores. The method and apparatus may further apply a feature pooling function to the selected one of said set of similarity vectors. The method and apparatus may further perform the step of sparsifying the selected one of the set of similarity vectors to reduce its dimensionality. The sparsifying operation may be configured to reduce dimensionality to a predetermined dimensionality corresponding to the requirements of a predetermined speech recognizer. Additionally, the processor may be programmed to decorrelate the selected one of the set of similarity vectors, as by applying a discrete cosine transform. The processor may also be programmed to compute at least one of velocity coefficients and acceleration coefficients and appending said at least one of velocity coefficients and acceleration coefficients to said selected one of said set of similarity vectors.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 depicts a hierarchical model of the SPARK feature extraction;

FIG. 2 depicts a set of gammatone kernel basis functions with center frequencies spanning 100 Hz to 4 kHz in the ERB space;

FIG. 3 is a three-dimensional plot showing a gammatone function shifted in time by 100 microseconds;

FIG. 4 is a signal flow diagram illustrating the SPARK feature extraction algorithm;

FIGS. 5a-5f (collectively FIG. 5) are spectrograms of vector s* and vector b for clean utterance (FIGS. 5a-5c) and 20-dB noisy utterance (FIGS. 5d-5f) of the digit “one;”

FIG. 6 (FIGS. 6a and 6b) depicts AURORA2 recognition results obtained under different convolutive noise conditions;

FIG. 7 (FIGS. 7a-7h) depict AURORA2 recognition results obtained under different additive noise conditions;

FIG. 8 is a signal flow diagram showing the feature extraction procedure using gammatone filter-bank;

FIG. 9 is a block diagram of a processor-based speech recognizer illustrating an exemplary use of the SPARK feature extractor;

FIG. 10 is a signal flow diagram useful in understanding the manner of generating the similarity function; and

FIG. 11 is a flow diagram illustrating the SPARK feature extraction and generation process.

Corresponding reference numerals indicate corresponding parts throughout the several views of the drawings.

### DETAILED DESCRIPTION

Example embodiments will now be described more fully with reference to the accompanying drawings.

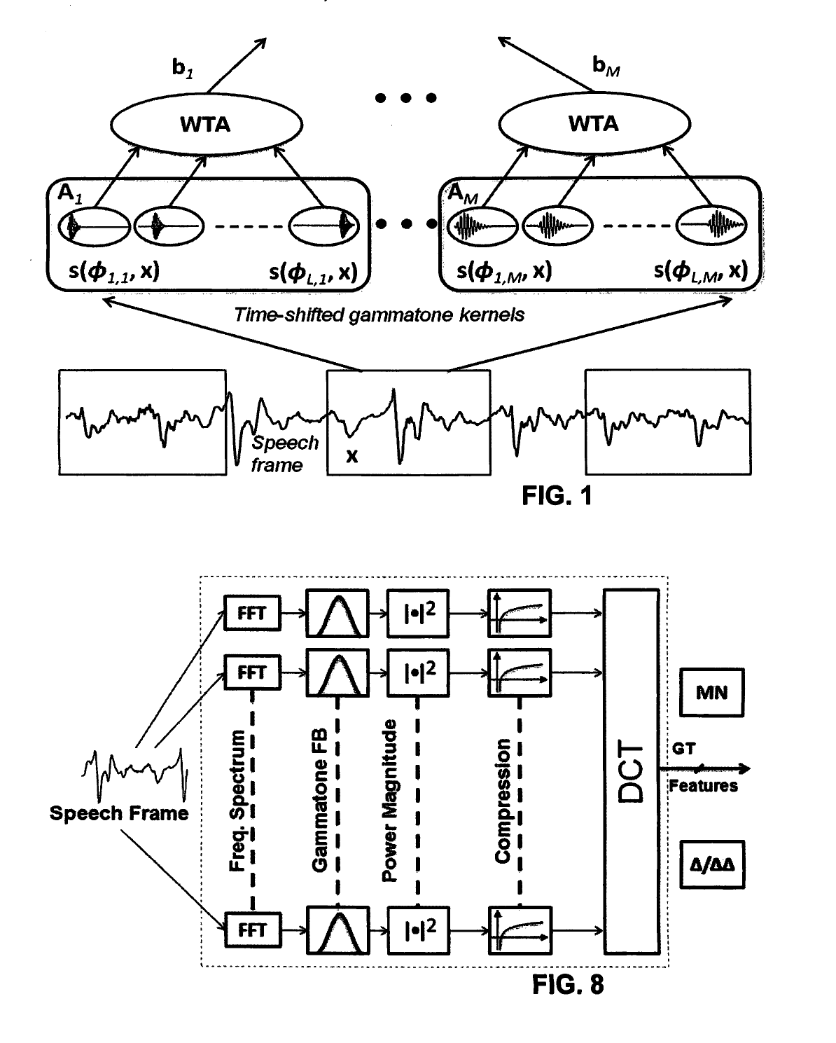

In this disclosure, we describe a computationally efficient hierarchical auditory feature extraction model using an RKHS based statistical learning approach. The model is summarized in FIG. 1 and consists of two signal-processing layers. The first layer computes the similarity between the sample speech signal and different sets A₁ to A_{M} of precomputed gammatone basis functions. Each set comprises of time-delayed versions of gammatone functions which emulates an auditory phase-sensitive receptive field. The second layer of the proposed model implements a winner-take-all (WTA) function which selects the largest of the similarity metric from each set A₁ to A_{M} (see FIG. 1). Based on the hierarchical model for computing SPARK features, this disclosure also discusses: 1) using RKHS functions to determine optimal auditory similarity functions that can capture the high-dimensional speech features; and 2) evaluating the effect of different RKHS parameters on the performance of a SPARK based speech recognition system.

The description below is organized as follows. Section I gives an overview of an exemplary automatic speech recognizer. The recognizer may be implemented using the SPARK features described herein. Section II describes the mathematical basis underlying the SPARK feature extraction algorithm. Section III presents experimental results summarizing the effect of different hyper-parameters and kernel functions when SPARK feature are evaluated for a speech recognition task using the AURORA2 corpus. Section IV discusses some further extensions of the SPARK technique. Section V concludes the disclosure with a discussion of how a SPARK feature extractor may be implemented using a suitable processor or set of processors. Before we present the SPARK algorithm we summarize some of the mathematical notations that will be used in this disclosure:
A (bold capital letters) denotes a matrix with its elements denoted by aᵢⱼ, i=1, 2, . . . ; j=1, 2, . . .
   and its row-wise vectors denoted by aᵢ, i=1, 2, . . .
x (normal lowercase letters) denotes a scalar variable.
x (bold lowercase letters) denotes a vector with its elements denoted by xᵢ, i=1, 2, . . .
x[n] denotes a sequence of scalars where n=1, 2, . . .
   denotes a discrete-time index.
Ψ(x) denotes a vector function whose elements are scalar functions denoted by ψ(x), i=1, 2, . . .
∥x∥ₚ denotes the Lₚ norm of a vector and is given by ∥x∥ₚ=(Σᵢ|xᵢ|^{p})^{1/p}
A^{T} denotes the transpose of A.
x·y denotes the inner-product between vectors x and y.

Section I. Exemplary Automatic Speech Recognition System

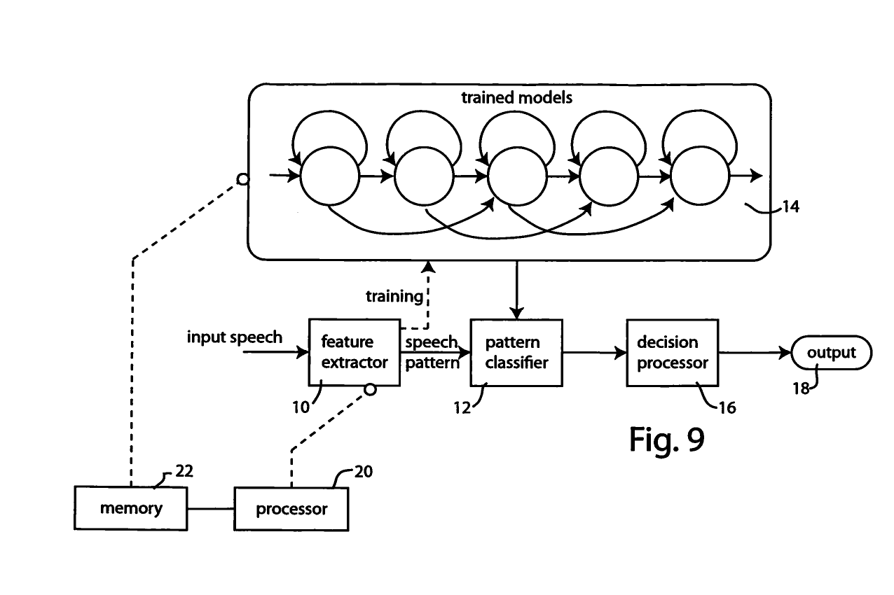

Referring to FIG. 9, the basic components of an exemplary automatic speech recognition system are illustrated. Input speech, captured via a suitable microphone or furnished in a data file previously recorded is supplied as input to the feature extractor 10. In a conventional recognition system the feature extractor 10 will typically extract cepstral coefficients. However, when the teachings of the present disclosure are used, the feature extractor implements the SPARK feature extraction technique and thus generates SPARK features. A further discussion of the SPARK feature extractor is provided below. Although not required, the SPARK feature extractor can include processing components to make the SPARK features compatible with existing recognizers, as will be discussed below.

The output of the feature extractor 10 is used first during training, to train the speech models 14. The output of the feature extractor 10 is subsequently used to convert incoming speech to be translated into the parameterized form used by the pattern classifier 12 during recognition. For illustration purposes the speech models 14 may be implemented as Hidden Markov Models (HMM) where the speech unit (phoneme, word, etc.) is represented by set of states (shown as circles) and transitions (shown as arrows), each having an associated probability distribution. The HMM model can be seen as a production model in which each transition corresponds to the emission of a speech frame or feature vector. To each state a corresponding probability distribution is assigned, representing the probability of producing an event. To each transition a probability distribution is also assigned, representing the probability of transitioning from that state to another state (or back to the same state).

The pattern classifier 12 computes a similarity measure between the input speech and each reference pattern represented by the trained models 14. The classifier process defines a local measure of closeness between feature vectors. The classifier also aligns two speech patterns so that they may be compared notwithstanding that they may differ in duration and rate of speaking.

The output of pattern classifier 12 is coupled to the decision processor 16 which selects the “closest” reference pattern based on decision rules that take into account the results of the similarity measurements (e.g., recognition probability scores). The pattern classifier 12 produces a recognition output 18 which may include a text-based representation of the recognized utterance, and/or an identification or verification of the speaker's identity, for example.

The feature extractor 10, pattern classifier 12 and decision processor 16 may be implemented using a programmed processor or computer 20 with associated computer-readable memory 22 which is configured to store the trained models 14. If desired the functionality represented by the feature extractor 10, pattern classifier 12 and decision processor 16 may be implemented by separate processors or computers that communicate with one another over a suitable communications link, such as the Internet. For example, the feature extractor 10 may be implemented using a processor within a mobile phone, the pattern classifier 12 and trained models 14 may be implemented using a processor located within a server coupled to the mobile phone by the telecommunications infrastructure. In such embodiment the decision processor may be implemented either on the server or on the processor within the mobile phone.

The SPARK feature extraction algorithm implemented by the preferred feature extractor 10 will now be described with reference to FIGS. 1-8.

Section II. Spark Feature Extraction Algorithm

In this section, we describe the mathematics underlying the SPARK feature extraction procedure. The first part of this analysis will involve deriving the mathematical form of the SPARK similarity functions based on RKHS regression techniques. For the analysis presented in this section, we will assume that a frame of speech signal is extracted using an appropriate windowing function (Hamming or Hanning).

A. SPARK Similarity Functions

As shown in FIG. 1, the similarity function s: [symbol] ^{P}× [symbol] ^{P}→ [symbol] is computed between a frame of speech signal (x[1], x[2], . . . , x[P]), compactly denoted by xε [symbol] ^{P}, and a set of precomputed basis vectors. For SPARK features, the basis vectors are constructed using a set of physiologically inspired gammatone functions φₘ(·), m=1, . . . , M, whose discrete-time representation is given by

φₘ[n]=aₘn^{θ-1} cos(2πƒₘn)e^{-πβERB(ƒ}^{ₘ}⁾ⁿ (1)

where ƒₘ is the center frequency parameter, aₘ is the amplitude, θ is the order of the gammatone basis, β is the parameter which controls the decay of the envelope along with a monotonic frequency dependent function ERB(·) called equivalent rectangular bandwidth (ERB) scale. One possible form of ERB(ƒₘ) which has been used in this disclosure, takes the form

ERB(ƒₘ)=0.108ƒₘ+24.7. (2)

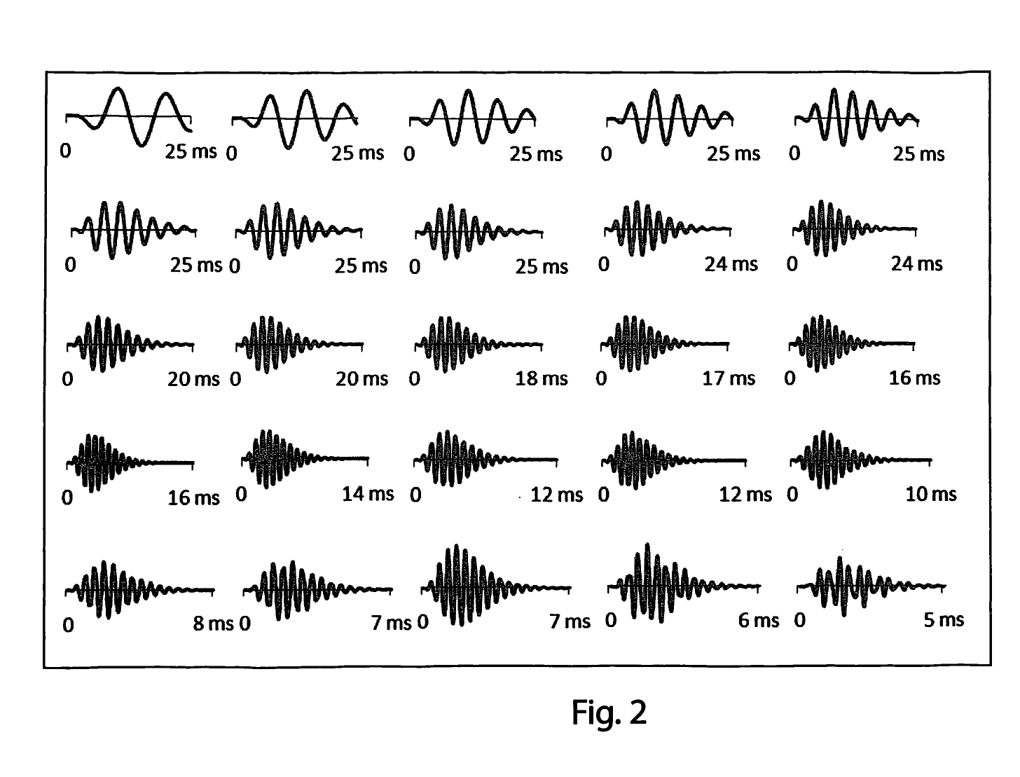

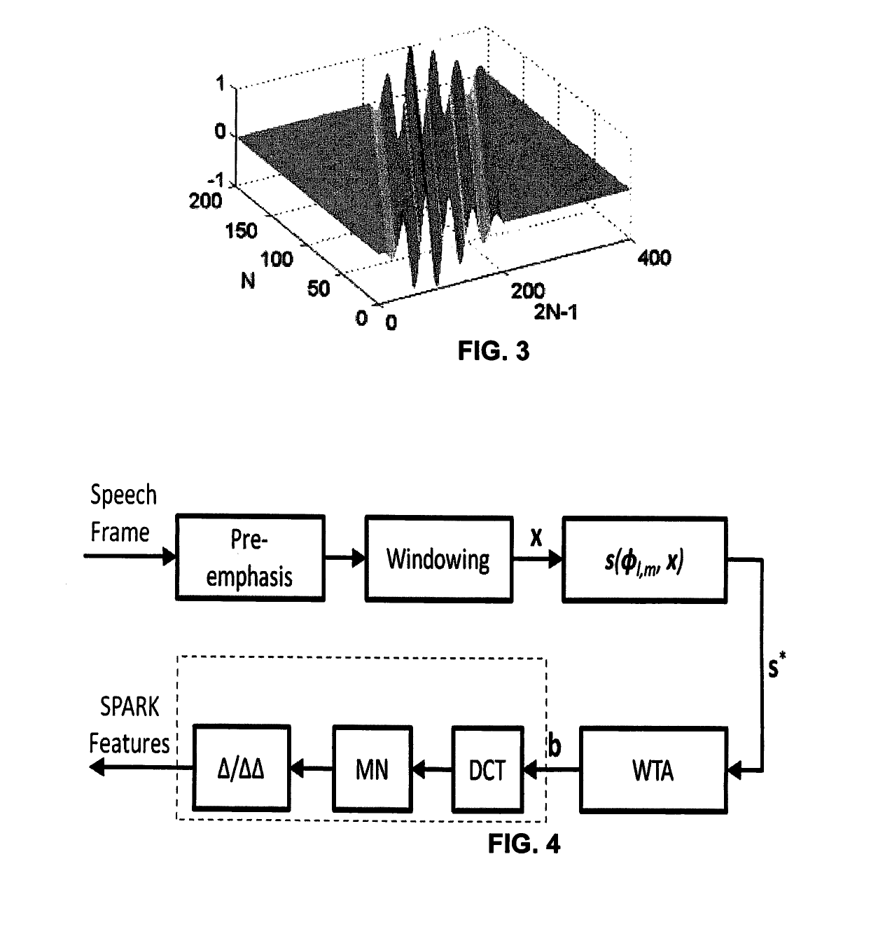

Also, in this disclosure we have chosen θ=4 and β=1.019. FIG. 2 shows the set of 25 gammatone basis vectors, each with different center frequencies ƒₘ. In the frequency domain, gammatone functions bear close resemblance to cochlear filter-banks due to the following characteristics: 1) nonuniform filter bandwidths where each of the frequency resolution is higher at the lower frequency than at the higher frequency; 2) peak gain of the filter centered at ƒₘ decreases as the level of the input increase, and 3) the cochlea filters are spaced more closely at lower frequencies than at higher frequencies. It can be shown that natural sounds can be sparsely and hence more compactly represented by a mixture of shift-invariant gammatone-type basis functions. Therefore, in our hierarchical SPARK model, we have chosen a basis set comprising of gammatone functions øₘ[n−τ_{l,m}] with different center frequency ƒₘ and with different temporal-shifts τ_{l,m} (see FIG. 3 which plots a gammatone function time-shifted by a unit time-interval). Incorporating different time-shifts in gammatone functions will be important for extracting phase information in speech signal which is effective in extracting the attributes of non-stationary part of speech signals (for, e.g., plosives).

We will compactly represent the discrete-time gammatone function øₘ[n−τ_{l,m}] φ_{l,m}□ [symbol] ^{P} and correspondingly the similarity function will be given by s(φ_{l,m},x). We now define a discrete-time waveform ƒ[n], n==1, . . . , P which constructed using the time-shifted basis functions according to

$$f [ n ] {\sum }_{m = 1}^{M} {\sum }_{l = 1}^{L} s ( {φ}_{l , m} , x ) {φ}_{m} [ n - {τ}_{l , m} ] . \qquad ( 3 )$$

Our objective will be to determine the form of the similarity functions s(φ_{l,m},x) by ensuring that the waveform ƒ[n] is close to the speech waveform x[n] according to some optimization criterion.

Before we present the optimization function, we rewrite the time-domain expressions in a matrix-vector notation as

f=φs (4)

where fε [symbol] ^{P} and sε [symbol] ^{L×M} is a vector given by s=[s_{1,1}, s_{1,2}, . . . , s_{L,M}]^{T} with its element given by s_{l,m}=s(φ_{l,m}, x). Φ ε [symbol] ^{P}× [symbol] ^{L×M} is a matrix given by Φ=[φ_{1,1}, . . . , φ_{L,M}]^{T}.

The optimization procedure for SPARK features involves minimizing a cost function with respect to, where is given by

$$C = λ \vert \vert s {\vert \vert}_{2}^{2} + \vert \vert x - f {\vert \vert}_{2}^{2} \qquad ( 5 )$$

The first part of the cost function acts as a regularizer which penalizes large values of s_{l,m}, thus favoring similarity measures that are smooth (or penalizes high-frequency components of the similarity function). The second part of the cost function C is the least-square error function computed between the speech vector and the reconstructed waveform ƒ[n]. The hyper-parameter λ in C controls the tradeoff between the achieving a lower reconstruction error and obtaining smoother similarity function. Equating the derivative

$$\frac{\partial C}{\partial s} = 2 π s - 2 {φ}^{T} ( x - φ s ) = 0$$

leads to

φ^{T}x=(φ^{T}φ+λI)s (6)

where I denotes an identity matrix. The optimal s* can be found to be

s*=[φ^{T}φ+λI]⁻¹]⁻¹φ^{T}x (7)

Equation (7) shows that the optimal similarity function s* is expressed in terms of inner-products between different timeshifted gammatone basis Φ^{T}Φ={φ_{l,m}·φ_{u,v}}; l,u=1, . . . , L; m,v=1, . . . M and between the time-shifted gammatone basis and the input speech vector Φ^{T}x={φ_{l,m}·x}. Equation (7) shows that the similarity function admits a linear form and involves computing inner-products. We extend this framework to a more general, nonlinear form of similarity functions by converting the inner-products in (7) into kernel expansions over the gammatone and the speech vectors.

We introduce a nonlinear transformation function ψ: [symbol] ^{P}→ [symbol] ^{D}, D>>P, which will map the vectors x and φ_{l,m} to a higher dimensional space according to x→ψ(x) and φ_{l,m}→ψ(φ_{l,m}). The high-dimensional mapping could consist of cross-correlation terms, for example, (x[1], x[2], . . . , x[P])→(x[1], x[2], {x[1]}², {x[2]}², {x[1]x[2]}, . . . ) which capture nonlinear attributes of the speech signal. Thus, extending (4) to the high-dimensional space, the reconstruction function fε [symbol] ^{D} can be written as

f=ψ(φ)s (8)

where ψ(Φ)ε [symbol] ^{D}× [symbol] ^{L×M} is a matrix given by ψ(Φ)=[ψ(φ_{1,1}), . . . , ψ(φ_{L,M}]^{T}. Then, following the regression procedure as described above, the similarity function can be expressed as inner-products in the higher dimensional space according to

$$\begin{matrix}{s}^{*} = {[ {φ}^{T} φ + λ I ]}^{- 1} {φ}^{T} x \\ {\to }^{ψ ( \cdot )} {[ {ψφ}^{T} ψ ( φ ) + λ I ]}^{- 1} {ψφ}^{T} ψ x\end{matrix} \qquad ( 9 )$$

Unfortunately, computing inner-products directly in the high-dimensional space is computationally intensive. The use of reproducing kernels avoids this “curse of dimensionality” by avoiding direct inner-product computation. For example, consider a nonlinear mapping of a two-dimensional vector yε [symbol] ² such that

$$( {y}_{1} , {y}_{2} ) {}^{ψ ( \cdot )} ( 1 , {y}_{1} , {y}_{2} , {y}_{2}^{2} , {y}_{2}^{2} , \sqrt{2} {y}_{1} , {y}_{2} ) .$$

The product between two vectors y, zε [symbol] ², in the high-dimensional space can be expressed as ψ(y)·ψ(z)=(1+y·z)² which requires computing inner-products only in the low-dimensional space, hence, is more computationally tractable. In general, any symmetric positive-definite function K(·,·)(also referred to as the reproducing kernel function) can be expressed as K(z,y)=ψ(x)·ψ(y) and hence can be used in (9). In literature, many forms of reproducing kernels have been reported, which includes the Gaussian radial basis function or the polynomial spline function. In neurophysiology, kernel functions have also been used for computing similarity measures in neural responses. Equation (9) can be expressed in terms of kernels as

s*=(K+λI)⁻¹K(φ,x) (10)

where Kε [symbol] ^{L×M}× [symbol] ^{L×M} is a RKHS kernel matrix with elements K(φ_{l,m},φ_{u,v}). Thus, a generic form of RKHS based similarity function can be expressed as

s(φ_{l,m},x)=(K+λI)⁻¹K(φ_{l,m},x) (11)

Note that the matrix inverse in (11) involves only the gammatone basis and hence can be precomputed and stored. Thus, the computation of the SPARK similarity metric involves computing kernels and a matrix-vector multiplication which can be made computationally efficient.

B. Feature Pooling

An important consequence of projecting the speech signal onto a gammatone function space (emulating the auditory STRFs) is that the highest scores (in ∥·∥₂ sense) in the similarity metric vector s will capture the salient, higher order, and the spectro-temporal aspects of the speech signal. On the other hand, the low-energy components of s will also capture similarities to noise and channel artifacts. Feature pooling serves two purposes. First, it introduces competitive masking, where only the largest similarity score is chosen. This function emulates the local competitive behavior which has been observed in auditory receptive fields. The second purpose of feature pooling is to introduce a compressive weighting function (similar to psycho-acoustical responses) which enhances the resolution at low similarity scores and reduces the resolution at high similarity scores. Mathematically, the output bₘ, m=1, . . . , M, resulting from feature pooling is given by

$${b}_{m} = ζ ( {max}_{l = 1}^{L} ( \vert {s}_{l , m} \vert ) ) \qquad ( 12 )$$

where ζ(·) is the compressive weighing function which could be a logarithmic (·) or a power function (·)^{1/p}, p>1. Note that the pooling is performed over a set consisting of time-shifted basis obtained from the same gammatone function.

C. SPARK Feature Extraction Signal-Flow

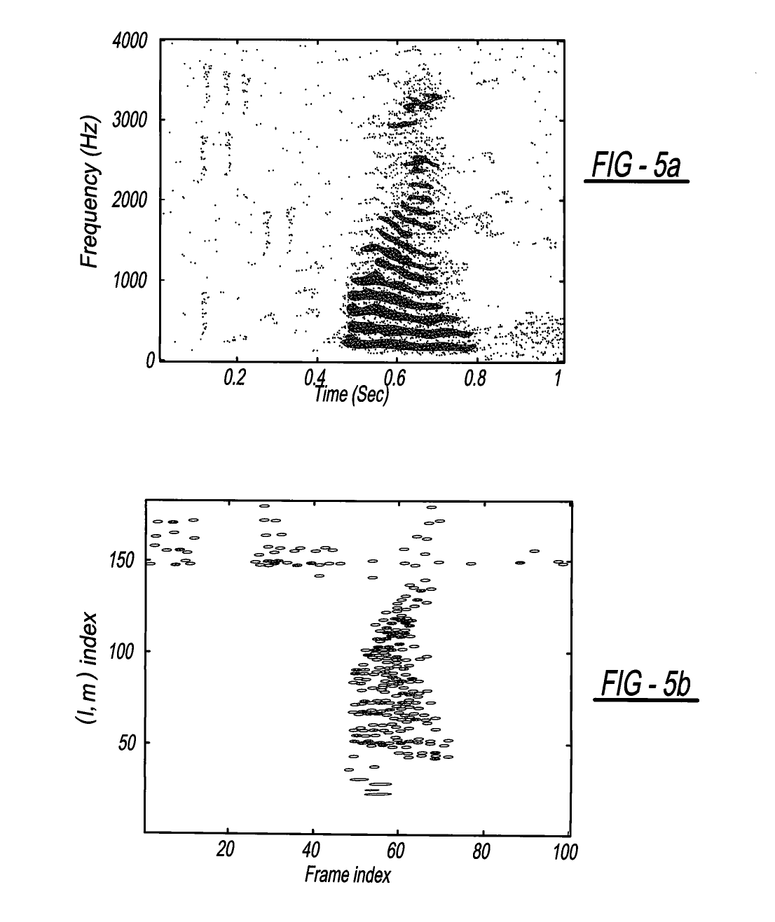

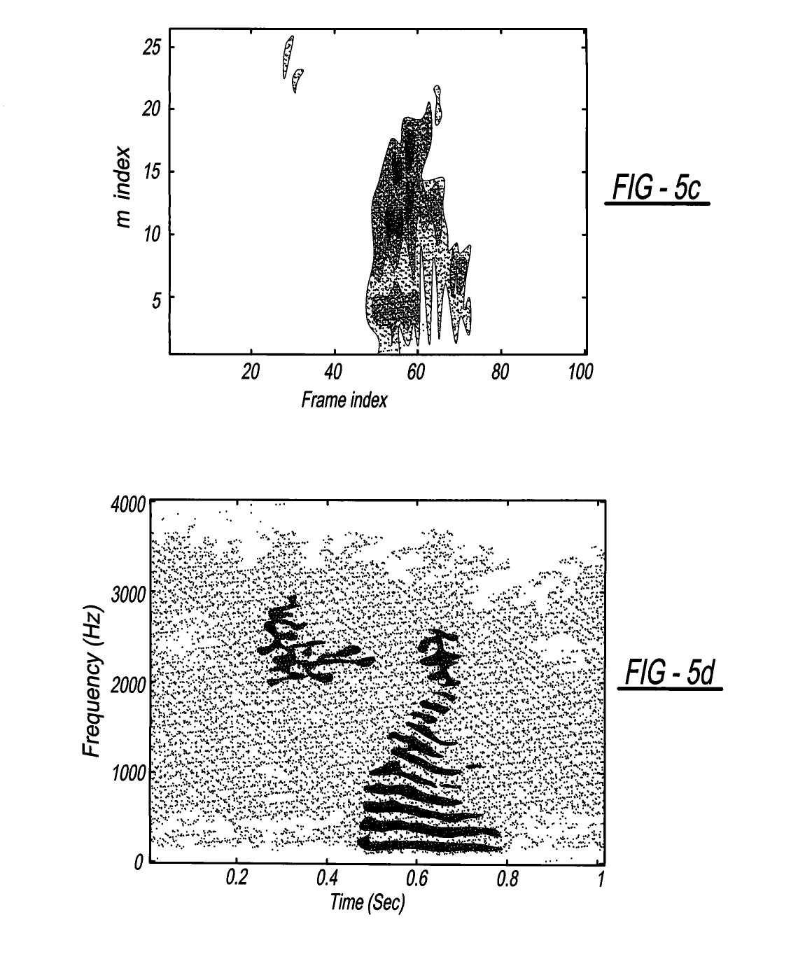

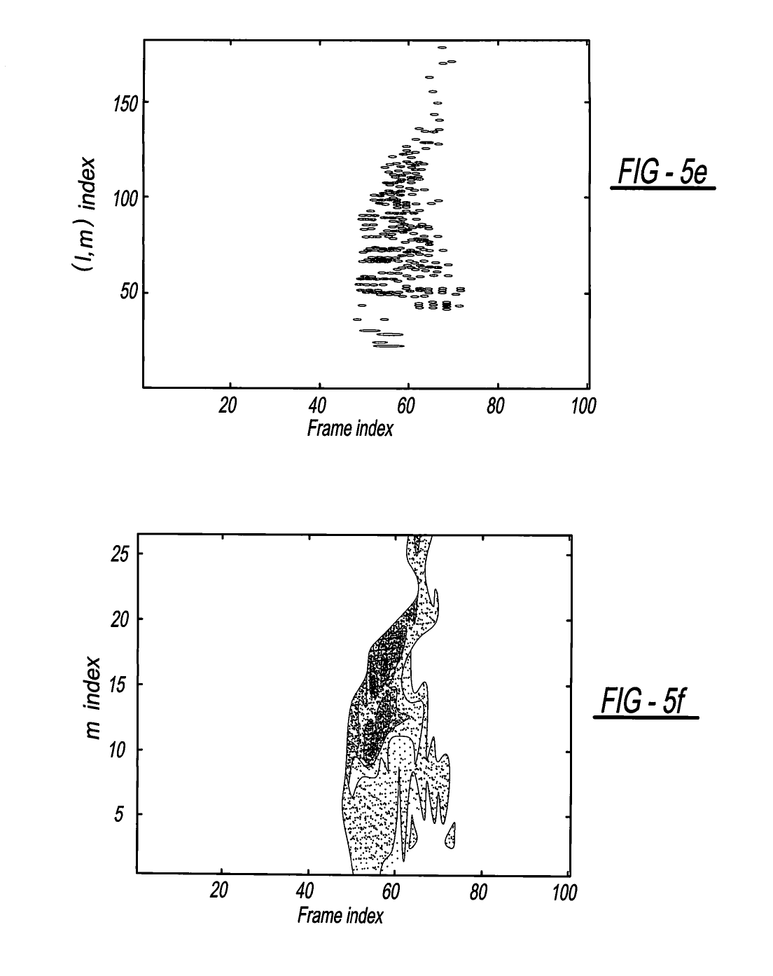

The flow-chart describing the complete SPARK feature extraction procedure is presented in FIG. 4. The input speech signal is processed by a pre-emphasis filter of the form xₚᵣₑ(t)=x(t)−0.97x(t−1) after which a 25-ms speech segment is extracted using a Hamming window. The similarity metric vector s*ε [symbol] ^{LM} is obtained using the procedure described in Section II-A and the sparsified vector bε [symbol] ^{M} is obtained based on the pooling procedure described in Section II-B. FIG. 5(a) and (d) shows the spectrograms of utterance “one” for clean and noisy (subway recording) conditions. FIG. 5(b) and (e) shows the similarity metric vector for each 25-ms speech segment shifted by 10 ms over clean and noisy speech utterances. Similarly, FIG. 5(c) and (f) shows the vector b for the same utterances. Similar to MFCC processing, a discrete cosine transform (DCT) is applied to de-correlate each of the vectors b. Mean normalization is then applied to each of these vectors and the SPARK features are obtained by appending the velocity Δ and acceleration ΔΔ coefficients (similar to MFCC processing). To ensure parity in comparison between the MFCC and SPARK-based features, we extracted 13 SPARK coefficients and concatenated additional 13 Δ and ΔΔ coefficients to form a 39-dimensional feature vector.

Section III. Experiments and Performance Evaluation

A. Experimental Setup

We have evaluated the SPARK features for the task of noise-robust speech recognition using the AURORA2 dataset. The AURORA2 task involves recognizing English digits in the presence of additive noise and convolutional noise. The task consists of three types of test sets. The first test set (set A) contains 4 subsets of 1001 utterances corrupted by subway, babble, car, and exhibition hall noises, respectively, at different SNR levels. The second set (set B) contains 4 subsets of 1001 utterances corrupted by restaurant, street, airport, and train station noises at different SNR levels. The test set C contains 2 subsets of 1001 sentences, corrupted by subway and street noises and was generated after filtering the speech with an MIRS filter before adding different types of noise.

For all the experiments reported in this paper, a hidden Markov model (HMM)-based speech recognizer has been used. The HMM recognizer was implemented using the hidden Markov toolkit (HTK) package. For each digit a whole word HMM was trained with 16 states per HMM and with three diagonal Gaussian mixture components per state. Additional HMMs were trained for the “sil” and “sp” models.

Next, we summarize the effect of different algorithmic hyper-parameters on the performance of a SPARK-based recognition system.

B. Effect of the Time-Shift Resolution

As we had described in Section II and shown in FIG. 3, the basis set comprises of time-shifts of gammatone functions. A set of M gammatone functions, each time-shifted L times would produce a total of L×M basis functions. Thus, reducing L would reduce the number of basis functions and also reduce the computational complexity of evaluating Eq. 11. In this experiment, we evaluate the effect of different time-shift resolution on the recognition performance of the system. The results which have been obtained for K(x,y)=tan h(0.01xy^{T}−0.01) and ζ=(·)^{1/13} are summarized in Table I. The result shows that smaller time-shifts (larger value of L) leads to better recognition results, however, at the expense of higher computational complexity. Thus, there exists a tradeoff between L, recognition performance and real-time requirements of the system.

TABLE I
The effect of different time-shifts on recognition performance.

| | Set A | Set B | Set C |
|---|---|---|---|
| SPARK; Shift = 100 μs | 72.83 | 73.62 | 71.97 |
| SPARK; Shift = 3 ms | 72.33 | 73.02 | 71.57 |
| SPARK; Shift = 4.5 ms | 71.79 | 72.48 | 70.97 |
| SPARK; Shift = 7.5 ms | 70.60 | 70.63 | 69.74 |

C. Effect of Different Kernel Functions

The generic form of the similarity function s(·,·) is given by (11) and is dependent on the choice of the kernel function K(·,·). In this experiment, we evaluated the effect of different types of RKHS functions on the recognition performance of the SPARK based system. The results are summarized in Table II for the following kernel functions: (a) linear K(x,y)=x·y; (b) exponential K(x,y)=exp(cx·y); (c) sigmoid K(x,y)=tan h(ax·y+c); and (d) polynomial K(x,y)=(x·y)^{d}. The results show that the choice of the kernel function affects the recognition performance, specifically, compared to the case when the linear kernel is used. The improvements in performance demonstrates the utility of exploiting nonlinear features in speech to achieve noise-robustness. Note that the best performance is obtained for a fourth-order polynomial kernel when we fixed Λ(·)=(·)^{1/15}.

TABLE II
The effect of different kernel functions
on recognition performance.

| | Set A | Set B | Set C |
|---|---|---|---|
| SPARK; Exponential kernel, c = 0.01 | 69.83 | 71.45 | 69.52 |
| SPARK; Exponential kernel, c = 1.0 | 69.22 | 71.16 | 68.24 |
| SPARK; Sigmoid kernel, a = 0.01, c = 0 | 68.35 | 70.60 | 68.89 |
| SPARK; Sigmoid kernel, a = 0.01, c = −0.01 | 69.84 | 71.48 | 69.54 |
| SPARK; Linear kernel | 67.80 | 69.65 | 68.30 |
| SPARK; Polynomial kernel, d = 2 | 70.77 | 71.14 | 71.07 |
| SPARK; Polynomial kernel, d = 4 | 67.89 | 68.24 | 68.05 |

D. Effect of Compressive Weighting Function

The compressive weighting function, as described in Section II-B, amplifies the lower values and de-amplifies larger values of the similarity metric. Table III summarizes the effect of different polynomial weighting functions on the performance of the SPARK-based speech recognition system (for K(x,y)=tan h(0.01xy^{T}−0.01)). The results indicate an optimal order of the weighing function that yields the best recognition performance.

TABLE III
The effect of compressive weighting
function on recognition performance.

| | Set A | Set B | Set C |
|---|---|---|---|
| SPARK; ζ(.) = (.)^{1/3} | 64.91 | 65.60 | 62.60 |
| SPARK; ζ(.) = (.)^{1/11} | 70.91 | 72.32 | 70.19 |
| SPARK; ζ(.) = (.)^{1/13} | 70.27 | 71.96 | 69.68 |
| SPARK; ζ(.) = (.)^{1/15} | 69.83 | 71.24 | 68.88 |
| SPARK; ζ(.) = (.)^{1/17} | 68.83 | 70.75 | 68.44 |
| SPARK; ζ(.) = (.)^{1/19} | 68.35 | 70.36 | 68.10 |

E. Effect of Parameter λ

Parameter λ is the regularization parameter which penalizes large values of the similarity metric and in the process makes the solution in (11) more stable. Table IV summarizes the effect of λ on the recognition performance and results show that solutions which penalizes the large values of S yields better recognition performance under noisy conditions.

TABLE IV
The effect of parameter λ on recognition performance.

| | Set A | Set B | Set C |
|---|---|---|---|
| SPARK λ = 0.1 | 71.63 | 72.01 | 70.59 |
| SPARK λ = 0.01 | 72.33 | 73.02 | 71.57 |
| SPARK λ = 0.0001 | 71.41 | 72.35 | 70.25 |
| SPARK λ = 0.00001 | 69.18 | 69.73 | 67.99 |
| SPARK λ = 0.000001 | 64.12 | 64.79 | 62.68 |

F. Comparison with the Basic ETSI Front-End (MFCC)

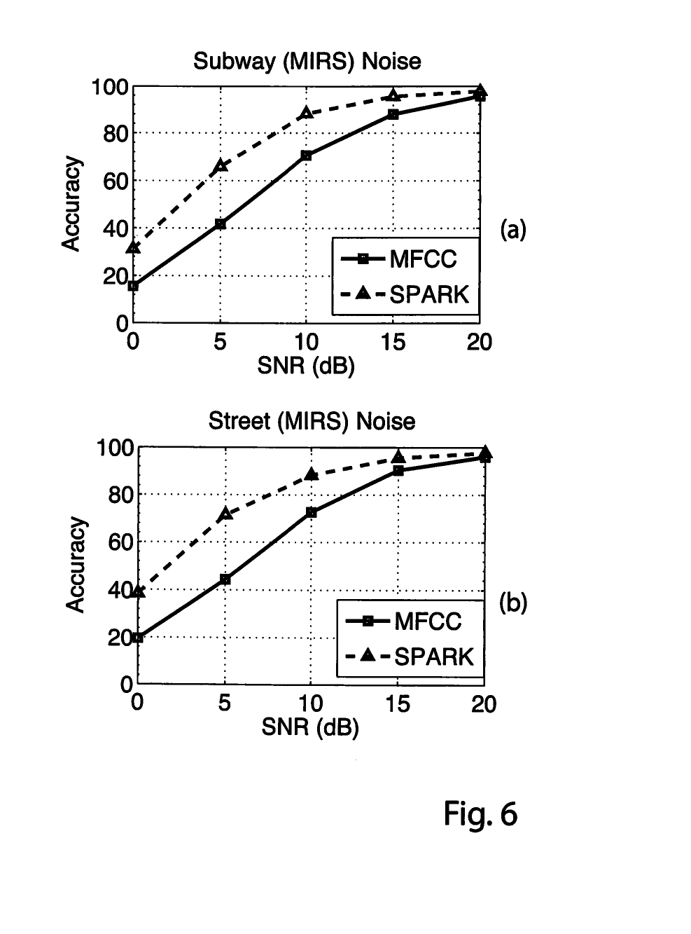

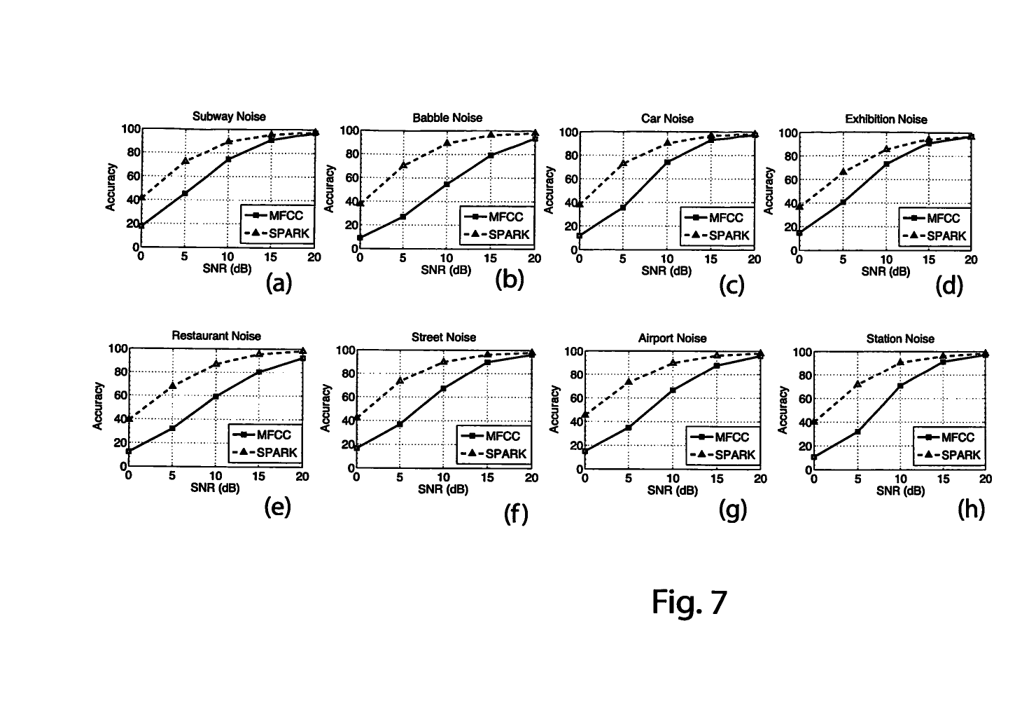

The accuracy of the SPARK-based recognition system has been compared against the baseline speech features extracted using the ETSI STQ WI007 DSR front-end. The basic ETSI front-end generates the 39-dimensional MFCC features without any cepstral mean normalization (CMN). FIGS. 6 and 7 compare the word recognition-rate obtained by the SPARK (with λ=0.01, weighting function of (·)^{1/15}, sigmoid kernel, and time-shift of 3.5 ms) and basic ETSI-based recognizers. The results show that the SPARK based recognition system consistently outperforms the benchmark at all SNR levels. The average relative word-accuracy improvement was found to be 33%, 36%, and 27% for set A, set B, and set C of the AURORA2 dataset.

G. Comparison with Gammatone Filter-Bank Based Features

The objective of the next set of experiments was to compare the SPARK features with gammatone filter-bank based features. The signal flow for the gammatone filter-bank features is shown in FIG. 8 which is similar to the MFCC feature extraction procedure except for the use of fourth-order gammatone filters instead of Mel-scale bandpass filters. The center frequencies were placed according to the ERB scale as described in Section II-A and similar to MFCC-based processing, a logarithmic compression, DCT, and CMS procedure is applied to the envelope of the output of each filter-bank. Δ and ΔΔ features are then concatenated to obtain the final set of features (labeled GT). Table V summarizes the AURORA2 recognition results obtained using the gammatone filter-bank features. Note that even though these features delivers improved recognition performance over the baseline MFCC-based system, the SPARK features yields superior word-accuracy (relative) improvements of 22%, 17%, and 18% for set A, set B, and set C when compared to the gammatone filter-bank features.

TABLE V
AURORA2 word recognition results when Gammatone
filter-bank (GT) features are used.

| | Set A | | | | |
|---|---|---|---|---|---|
| | Babble | Subway | Car | Exhibition | Average |
| Clean | 99.33 | 99.23 | 98.96 | 99.26 | 99.20 |
| 20 dB | 97.94 | 96.62 | 96.99 | 96.67 | 97.06 |
| 15 dB | 94.71 | 92.60 | 93.47 | 91.89 | 93.17 |
| 10 dB | 83.40 | 79.61 | 78.20 | 77.75 | 79.74 |
| 5 dB | 53.08 | 50.26 | 41.57 | 46.37 | 47.82 |
| 0 dB | 22.43 | 23.55 | 19.83 | 20.67 | 21.62 |
| −5 dB | 12.76 | 14.86 | 12.47 | 12.22 | 13.08 |
| Average | 66.24 | 65.25 | 63.07 | 63.55 | 64.53 |

| | Set B | | | | |
|---|---|---|---|---|---|
| | Restaurant | Street | Airport | Station | Average |
| Clean | 99.23 | 99.33 | 98.96 | 99.26 | 99.20 |
| 20 dB | 97.97 | 97.58 | 97.67 | 97.81 | 97.76 |
| 15 dB | 95.33 | 93.65 | 95.23 | 94.97 | 94.80 |
| 10 dB | 85.69 | 82.44 | 86.85 | 83.52 | 84.63 |
| 5 dB | 60.12 | 53.02 | 59.23 | 52.92 | 56.32 |
| 0 dB | 27.30 | 23.61 | 28.93 | 24.28 | 26.03 |
| −5 dB | 12.96 | 12.85 | 15.00 | 13.92 | 13.68 |
| Average | 68.37 | 66.07 | 68.84 | 66.67 | 67.49 |

| | Set C | | |
|---|---|---|---|
| | Subway (MIRS) | Street (MIRS) | Average |
| Clean | 99.14 | 99.37 | 99.26 |
| 20 dB | 96.90 | 97.49 | 97.20 |
| 15 dB | 92.88 | 93.38 | 93.13 |
| 10 dB | 80.04 | 81.08 | 80.56 |
| 5 dB | 50.60 | 52.09 | 51.35 |
| 0 dB | 23.55 | 22.70 | 23.13 |
| −5 dB | 14.55 | 12.73 | 13.64 |
| Average | 65.38 | 65.55 | 65.46 |

H. Comparison with ETSI AFE

The last set of experiments compared the SPARK features to the state-of-the-art ETSI AFE front-end. The ETSI AFE uses noise estimation, two-pass Wiener filter-based noise suppression, and blind feature equalization techniques. To incorporate an equivalent noise-compensation to the SPARK features, we used a power bias subtraction (PBS) method. PBS method resembles in some ways to the conventional spectral subtraction (SS), but instead of estimating noise from non-speech parts which usually needs a very accurate voice activity detector (VAD), PBS simply subtracts a bias where the bias is adaptively computed based on the level of the background noise. Tables VI and VII compares the performance of ETSI AFE and SPARK+PBS (λ=0.01) recognition system under different types of noise. Even though for Set A, the performance improvement of the SPARK+PBS system over the ETSI AFE system is not statistically significant, for Set B and Set C SPARK+PBS system consistently outperforms the ETSI AFE for all types of noise except subway and exhibition noise at low SNR. In fact, SPARK shows an overall relative improvements of 4.69% with respect to the ETSI AFE which is statistically significant.

TABLE VI
AURORA2 word recognition results when ETSI AFE is used.

| | Set A | | | | |
|---|---|---|---|---|---|
| | Babble | Subway | Car | Exhibition | Average |
| Clean | 99.00 | 99.08 | 99.05 | 99.23 | 99.09 |
| 20 dB | 98.31 | 97.91 | 98.48 | 97.90 | 98.15 |
| 15 dB | 96.89 | 96.41 | 97.58 | 96.82 | 96.93 |
| 10 dB | 92.35 | 92.23 | 95.29 | 92.78 | 93.16 |
| 5 dB | 81.08 | 83.82 | 88.49 | 84.05 | 84.36 |
| 0 dB | 51.90 | 61.93 | 66.42 | 63.28 | 60.88 |
| −5 dB | 19.71 | 30.86 | 30.84 | 32.86 | 28.57 |
| Average | 77.03 | 80.32 | 82.31 | 80.99 | 80.16 |

| | Set B | | | | |
|---|---|---|---|---|---|
| | Restaurant | Street | Airport | Station | Average |
| Clean | 99.08 | 99.00 | 99.05 | 99.23 | 99.09 |
| 20 dB | 97.97 | 97.64 | 98.39 | 98.36 | 98.09 |
| 15 dB | 95.33 | 96.74 | 97.11 | 96.73 | 96.48 |
| 10 dB | 90.08 | 92.78 | 93.47 | 93.77 | 92.53 |
| 5 dB | 76.27 | 83.28 | 84.07 | 84.57 | 82.05 |
| 0 dB | 51.09 | 60.07 | 60.99 | 62.57 | 58.68 |
| −5 dB | 18.67 | 29.87 | 28.54 | 29.96 | 26.76 |
| Average | 75.50 | 79.91 | 80.23 | 80.74 | 79.10 |

| | Set C | | |
|---|---|---|---|
| | Subway (MIRS) | Street (MIRS) | Average |
| Clean | 99.08 | 99.03 | 99.06 |
| 20 dB | 97.36 | 97.70 | 97.53 |
| 15 dB | 95.33 | 95.77 | 95.55 |
| 10 dB | 90.24 | 90.69 | 90.47 |
| 5 dB | 79.03 | 78.17 | 78.60 |
| 0 dB | 51.73 | 52.09 | 51.91 |
| −5 dB | 24.62 | 25.57 | 25.10 |
| Average | 76.77 | 77.00 | 76.89 |

TABLE VII
AURORA2 word recognition results when
SPARK and PBS are used together.

| | Set A | | | | |
|---|---|---|---|---|---|
| | Babble | Subway | Car | Exhibition | Average |
| Clean | 99.12 | 99.36 | 99.19 | 99.38 | 99.26 |
| 20 dB | 98.70 | 98.10 | 98.69 | 98.15 | 98.41 |
| 15 dB | 97.64 | 96.41 | 98.03 | 96.64 | 97.18 |
| 10 dB | 95.37 | 92.94 | 95.47 | 92.69 | 94.12 |
| 5 dB | 86.61 | 82.87 | 88.76 | 81.67 | 84.98 |
| 0 dB | 58.19 | 59.26 | 71.28 | 56.77 | 61.38 |
| −5 dB | 21.58 | 27.97 | 34.54 | 25.24 | 27.33 |
| Average | 79.60 | 79.56 | 83.71 | 78.65 | 80.38 |

| | Set B | | | | |
|---|---|---|---|---|---|
| | Restaurant | Street | Airport | Station | Average |
| Clean | 99.36 | 99.12 | 99.19 | 99.38 | 99.26 |
| 20 dB | 98.83 | 98.37 | 98.90 | 98.58 | 98.67 |
| 15 dB | 97.51 | 97.58 | 98.30 | 97.59 | 97.75 |
| 10 dB | 94.32 | 94.04 | 96.60 | 95.06 | 95.01 |
| 5 dB | 82.99 | 84.22 | 89.41 | 86.76 | 85.85 |
| 0 dB | 56.77 | 60.85 | 69.52 | 66.52 | 63.42 |
| −5 dB | 21.95 | 27.48 | 32.03 | 33.35 | 28.70 |
| Average | 78.82 | 80.24 | 83.42 | 82.46 | 81.24 |

| | Set C | | |
|---|---|---|---|
| | Subway (MIRS) | Street (MIRS) | Average |
| Clean | 99.32 | 99.09 | 99.21 |
| 20 dB | 97.82 | 98.04 | 97.93 |
| 15 dB | 96.41 | 96.80 | 96.61 |
| 10 dB | 92.05 | 93.59 | 92.82 |
| 5 dB | 80.60 | 82.98 | 81.79 |
| 0 dB | 54.81 | 57.13 | 55.97 |
| −5 dB | 25.02 | 25.57 | 25.30 |
| Average | 78.00 | 79.03 | 78.52 |

Table VIII shows a comparative performance of SPARK+PBS features against basic ETSI FE, conventional gammatone filterbank, and ETSI AFE. Even under dean recording conditions, the SPARK+PBS demonstrates improvement over the baseline ETSI AFE system but the advantage of SPARK+PBS features becomes more apparent under noisy conditions.

TABLE VIII
Summary of recognition performances
obtained for the AURORA2 database.

| | Set A | Set B | Set C |
|---|---|---|---|
| ETSI FE WI007 | 58.67 | 57.59 | 60.83 |
| ETSI AFE WI008 | 80.16 | 79.10 | 76.89 |
| Conventional GT | 64.53 | 67.49 | 65.46 |
| SPARK + PBS | 80.38 | 81.24 | 78.52 |

Section IV. Extending the Spark Technique

In this disclosure, we have presented a framework for extracting noise-robust speech features called sparse auditory reproducing kernel (SPARK) coefficients. The approach follows a computationally efficient hierarchical model where parallel similarity functions (emulating neurobiologically inspired auditory receptive fields) are computed followed by a pooling method (emulating neurobiologically inspired local competitive behavior). In this disclosure, we have derived an optimal form of the similarity functions which uses reproducing kernels to capture the nonlinear information embedded in the speech signal. Experimental results obtained for the AURORA2 speech recognition tasks demonstrate that the following:

Under clean recording conditions, the performance of both baseline MFCC and SPARK based systems are comparable with a recognition accuracy of 99.25%. The result is consistent with other state-of-the-art results reported for the AURORA2 dataset.

The SPARK features demonstrate a more robust performance in the presence of both additive and convolutive noise. We have demonstrated that SPARK can achieve average word recognition rates of 80.38%, 81.24%, and 78.52% for sets A, B, and C of the AURORA2 corpus. We have also shown that for the AURORA2 task, SPARK features combined with the PBS technique consistently out-performs the state-of-the-art ETSI AFE based features.

A possible extension to this work, to further improve noise-robustness, can be achieved by incorporating L1 metric instead of an L2 metric in the regression framework (5). We anticipate that this procedure, even though is more computationally intensive, could lead to more noise-robust speech features.

Section V. Processor Implementation of the Spark Feature Extractor

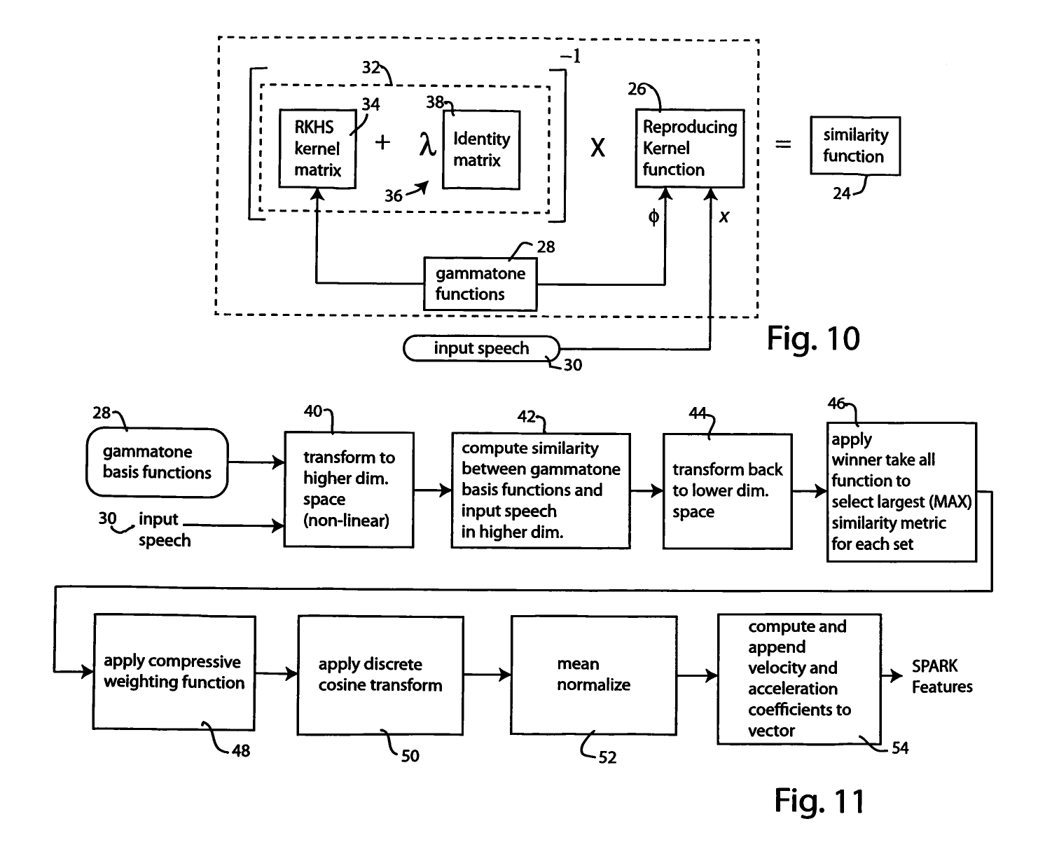

FIG. 9 illustrated how a speech recognizer may be configured to use the SPARK feature extractor of the present disclosure. FIGS. 10 and 11 will now provide further details of how the feature extractor 10 may be implemented using a processor. Specifically, FIG. 10 shows how the processor may be programmed to calculate the similarity function 24 used by the SPARK feature extraction process. FIG. 11 shows how the processor may be programmed to implement the SPARK feature extraction, and also how to put the extracted features into a form that can be used with a standard recognizer such as an HMM-based recognizer.

As discussed above, the SPARK feature extractor 10 applies a similarity function to compare the incoming speech to a set of time-shifted gammatone kernels. Referring to FIG. 10, the similarity function 24 comprises a reproducing Kernel function 26, which receives as inputs the set of gammatone functions 28 and the input speech signal 30. It is assumed that the input speech signal 30 has been windowed at this point using a suitable Hamming window or Hanning window process; thus the speech signal corresponds to a vector of time-domain samples corresponding to that window of speech, as diagrammatically shown in FIG. 1. The gammotone basis functions 28 are likewise represented as a set of vectors of time-domain samples, for each of the gammatone waveforms shown in FIG. 1 and also in FIG. 2.

A property of the reproducing Kernel function 26 is that it transforms the input data into a higher-dimensional space, effecting a non-linear transformation in the process. As discussed above, this non-linearity is a desirable property because it modifies the gammatone waveforms to more closely model the properties of human hearing.

The reproducing kernel function 26 is then transformed back into lower-dimensional space by multiplying it by an inverse matrix shown in dashed lines at 32. The inverse matrix comprises two components, a reproducing kernel Hilbert space (RKHS) matrix 34 and an optimization parameter 36 implemented by applying the regularization parameter discussed in Section III E. above to the identity matrix 38. Multiplying the reproducing Kernel function 26 with the inverse matrix 32 transforms the resulting matrix back to the original lower-dimensional space.

Note that while the reproducing Kernel function 26 receives both the gammatone functions 28 and the input speech 30 as inputs, the inverse matrix requires only the gammatone functions 28 (which are supplied as inputs to the RKHS kernel matrix 34). This means that the entire inverse matrix can be precomputed (before any input speech is received). The precomputed values of the inverse matrix 32 are stored in memory 22 (FIG. 9) where they can be readily used to multiply with the reproducing kernel function 26 in a computationally efficient manner.

With this understanding of the similarity function 24, refer now to FIG. 11 which illustrates how to program the processor 20 (shown in FIG. 9) to implement the feature extractor 10. The gammatone basis functions 28 are stored in memory (such as memory 22 of FIG. 9). The processor is then programmed to apply the reproducing Kernel function 26 as at 40 to transform the gammatone basis functions 28 and input speech into a higher dimensional reproducing kernel Hilbert space. To compute the similarity between the gammatone basis functions and the input speech, as at 40, the speech signal vector is multiplied by each of the set of gammatone basis vectors, with the result that the basis vectors that are closer to the speech signal vector will have a higher output. Next the results are transformed back to lower dimensional space at 44, using the inverse matrix operation 32 of FIG. 10.

At this point the output represents a set of similarity value gammatone basis-speech vector products. A winner-takes-all function is then applied at 46, to select one of the set of products that represents the largest output. This is referred to in the above discussion as the MAX operation. After making the winner-takes-all selection, the resulting output is a single vector, of the same dimensionality as the input speech signal. However, whereas the input speech signal corresponded to time domain parameters, the output of the winner-takes-all function is a raw SPARK vector. The original time-domain speech signal has been transformed into non-linear, time-shifted gammatone similarity parameters.

In many applications it is helpful to further reduce the dimensionality of the speech representation. Thus the processor is programmed to apply a compressive weighting function at 48. This weighting function is discussed above in Section II. E. on Feature Pooling. After applying the compressive weighting function the SPARK speech parameters are improved to by enhancing the resolution at low similarity scores while reducing resolution at high similarity scores.

The remaining steps shown in FIG. 11 are optional, but desirable if the SPARK features will be used with standard recognizer architectures. To perform these additional steps the processor is programmed to apply a discrete cosine transform (DCT) to the SPARK feature parameters. The discrete cosine transform has the effect of converting the individual parameters into fixed-point number, which may be handed by subsequent processing steps more efficiently than floating-point numbers. The DCT transform also tends to de-correlate the individual parameters, so that they are more orthogonal and thus better able to capture and represent fine detail. The output parameters of the DCT transform are then mean normalized at 52. If desired, velocity and acceleration coefficients may then be calculated at 54 and these are then appended to the SPARK feature vector to provide additional detail to the SPARK feature parameters.

In a mobile device application, such as in a mobile phone application, the SPARK features may be computed using the onboard processor of the mobile device, running as a background application or a thread. Alternatively, a separate digital signal processing circuit (DSP) can be included in the mobile device to compute the SPARK features. If desired, the features may be generated using an analog embodiment whereby analog bandpass filters are used to generate the features. An application specific integrated circuit (ASIC) can be used to implement this.

The SPARK features may be computed or generated in the mobile device and then sent wirelessly to an Internet-based or cloud-based server system for further recognition processing. If desired, the SPARK features can be used for speaker identification, so that the speaker's voice can be used to authenticate himself or herself to the mobile device. In this regard, speaker identification or authentication can serve as a way for a user to activate the mobile device without the need to manually type a pass phrase or password. The ability to enter such authentication or identification information by voice is particularly advantageous with mobile devices, such as watches or other small devices worn on the user's body, that do not have large touchscreens or keypads for pass phrase or password entry.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of processing time domain speech signal digitally represented as a vector of a first dimension, comprising:
storing the time domain speech signal in the memory of said processor;
representing a set of gammatone basis functions as a set of gammatone basis vectors of said first dimension and storing said gammatone basis vectors in the memory of a processor;
using the processor to apply a reproducing kernel function to transform the stored gammatone basis vectors and the stored speech signal to a higher dimensional space;
using the processor to compute a set of similarity vectors in said higher dimensional space based on the stored gammatone basis vectors and the stored speech signal;
using the processor to apply an inverse function to transform the set of similarity vectors in said higher dimensional space to a set of similarity vectors of the first dimension; and
using the processor to select one of said set of similarity vectors of the first dimension as a processed representation of said speech signal.

2. The method of claim 1 wherein the transformation from higher dimensional space to the first dimension effects a nonlinear transformation.

3. The method of claim 1 wherein the step of applying said inverse function includes applying a regularization parameter that penalizes large similarity values to enhance robustness of the processed representation of said speech signal in the presence of noise.

4. The method of claim 1 further comprising applying a windowing function to the time domain speech signal prior to computing the set of similarity vectors.

5. The method of claim 1 wherein said higher dimensional space is a Hilbert space.

6. The method of claim 1 wherein the step of selecting one of said set of similarity vectors is performed by applying a winner-take-all function.

7. The method of claim 1 further comprising using the processor to apply a compressive weighting function to the selected one of said set of similarity vectors.

8. The method of claim 1 further comprising using the processor to apply a compressive weighting function to the selected one of said set of similarity vectors to enhance the resolution at low similarity scores and reduce the resolution at high similarity scores.

9. The method of claim 1 further comprising applying a feature pooling function to the selected one of said set of similarity vectors.

10. The method of claim 1 further comprising precomputing and storing in memory a transformation matrix and using said transformation matrix to perform the step of applying an inverse function.

11. The method of claim 1 further comprising sparsifying the selected one of the set of similarity vectors to reduce its dimensionality.

12. The method of claim 1 further comprising sparsifying the selected one of the set of similarity vectors to reduce its dimensionality to a predetermined dimensionality corresponding to the requirements of a predetermined speech recognizer.

13. The method of claim 1 decorrelating the selected one of the set of similarity vectors.

14. The method of claim 12 further comprising decorrelating the sparsified selected one of the set of similarity vectors.

15. The method of claim 13 or 14 wherein the decorrelating step is performed by applying a discrete cosine transform.

16. The method of claim 1 further comprising normalizing the selected one of the set of similarity vectors to conform to the requirements of a predetermined speech recognizer.

17. The method of claim 1 further comprising using the processor to compute at least one of velocity coefficients and acceleration coefficients and appending said at least one of velocity coefficients and acceleration coefficients to said selected one of said set of similarity vectors.

18. An apparatus for processing digitized speech signals comprising:
a memory configured to store a set of gammatone basis vectors;
a processor coupled to said memory and having an input to receive said digitized speech signals, said processor being programmed to transform the stored set of gammatone basis vectors and said digitized speech signals by applying a reproducing kernel function to generate and store in said memory representations of said gammatone basis vectors and said digitized speech signals in a higher dimension;
said processor being further programmed to compute a set of similarity vectors using said representations of said gammatone basis vectors and said digitized speech signals in said higher dimension and then transform the set of similarity vectors to a lower dimension;
said processor being further programmed to select one of said set of similarity vectors to said lower dimension and providing said selected one of said set of similarity vectors as a processed representation of said speech signal.

19. The apparatus of claim 18 further comprising a speech recognizer having a set of trained models stored in a memory, the trained models being trained upon speech signal utterances represented using said selected one of said set of similarity vectors.

20. The apparatus of claim 18 further comprising a speech recognizer having a set of trained models stored in a memory and having a pattern classifier coupled to said set of trained models, the pattern classifier having an input receptive of speech signal utterances represented using said selected one of said set of similarity vectors.

21. The apparatus of claim 18 wherein the processor is programmed to apply a nonlinear transformation upon said gammatone basis vectors and said digitized speech signals.

22. The apparatus of claim 18 wherein the processor is programmed to apply a regularization parameter in computing said set of similarity vectors that penalizes large similarity values to enhance robustness of the processed representation of said speech signal in the presence of noise.

23. The apparatus of claim 18 further wherein the processor is programmed to apply a windowing function to the speech signals prior to computing the set of similarity vectors.

24. The apparatus of claim 18 wherein said higher dimension corresponds to a Hilbert space representation of said gammatone basis vectors and said digitized speech signals.

25. The apparatus of claim 18 wherein the processor is programmed to select one of said set of similarity vectors by applying a winner-take-all function.

26. The apparatus of claim 18 further comprising using the processor to apply a compressive weighting function to the selected one of said set of similarity vectors.

27. The apparatus of claim 18 further comprising using the processor to apply a compressive weighting function to the selected one of said set of similarity vectors to enhance the resolution at low similarity scores and reduce the resolution at high similarity scores.

28. The apparatus of claim 18 further comprising using said processor to apply a feature pooling function to the selected one of said set of similarity vectors.

29. The apparatus of claim 18 further comprising a memory configured to store a precomputing transformation matrix used by said processor to transform the set of similarity vectors to a lower dimension.

30. The apparatus of claim 18 wherein said processor is programmed to sparsify the selected one of the set of similarity vectors to reduce its dimensionality.

31. The apparatus of claim 18 wherein said processor is programmed to sparsify the selected one of the set of similarity vectors to reduce its dimensionality to a predetermined dimensionality corresponding to the requirements of a predetermined speech recognizer.

32. The apparatus of claim 18 wherein said processor is programmed to decorrelate the selected one of the set of similarity vectors.

33. The apparatus of claim 31 wherein said processor is programmed to decorrelate the sparsified selected one of the set of similarity vectors.

34. The apparatus of claim 32 or 33 wherein said processor is programmed to decorrelate the selected one of the set of similarity vectors by applying a discrete cosine transform.

35. The apparatus of claim 18 wherein the processor is programmed to normalize the selected one of the set of similarity vectors to conform to the requirements of a predetermined speech recognizes.

36. The apparatus of claim 18 further comprising using the processor to compute at least one of velocity coefficients and acceleration coefficients and appending said at least one of velocity coefficients and acceleration coefficients to said selected one of said set of similarity vectors.
